(19) United States
(12) Patent Application Publication
(10) Pub. No.: US 2026/0313546 A1
(43) Pub. Date: Oct. 8, 2026

(54) SLEEP UNIT COMMAND

(71) Applicant: QUALCOMM Incorporated, San Diego, CA (US)

(72) Inventors: Ahmed Abdelaziz Ibrahim Abdelaziz ZEWAIL, San Diego, CA (US); Chengjin ZHANG, San Diego, CA (US); Zhifei FAN, San Diego, CA (US)

(21) Appl. No.: 19/169,731

(22) Filed: Apr. 3, 2025

(51) Int. Cl. H04W 52/02

(52) U.S. Cl. CPC H04W 52/0235; H04W 52/0219; H04W 52/0287

(57) ABSTRACT

In some aspects, a first wireless device may transmit a query command that includes a query parameter assigned to one or more second wireless devices and that requests a response from each of the one or more second wireless devices. The first wireless device may transmit a sleep unit command that is associated with sleep unit durations for the one or more second wireless devices. The first wireless device may transmit, a sleep unit duration after the sleep unit command, a query repeat command that indicates a zero count of query repeat commands transmitted since the query command. The first wireless device may transmit one or more other query repeat commands that each indicate a count of query repeat commands transmitted since the query command. The first wireless device may monitor for responses from the one or more other devices. Numerous other aspects are described.

### FIELD OF THE DISCLOSURE

Aspects of the present disclosure generally relate to wireless communication and, for example, to a sleep unit for devices.

### BACKGROUND

Wireless communication systems are widely deployed to provide various types of communication content such as voice, video, packet data, messaging, broadcast, and so on. These systems may be multiple-access systems capable of supporting communication with multiple users by sharing the available system resources (for example, time, frequency, and power). A wireless network (e.g., a wireless local area network (WLAN), such as a Wi-Fi (for example, Institute of Electrical and Electronics Engineers (IEEE) 802.11) network) may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a station may communicate with an associated AP via downlink and uplink. “Downlink” may refer to the communication link from the AP to the station, and “uplink” may refer to the communication link from the station to the AP.

The AP may be coupled to a network, such as the Internet, and may enable a mobile device to communicate via the network (or communicate with other devices coupled to the AP). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (WPAN), which may include a Bluetooth® connection, may provide for short range wireless connections between two or more paired wireless devices. For example, wireless devices such as cellular phones may utilize WPAN communications to exchange information such as audio signals with wireless headsets.

### SUMMARY

Some aspects described herein relate to a method of wireless communication performed by a first wireless device. The method may include transmitting a query command that includes a query parameter assigned to one or more second wireless devices and that requests a response from each of the one or more second wireless devices. The method may include transmitting a sleep unit command that is associated with sleep unit durations for the one or more second wireless devices. The method may include transmitting, a sleep unit duration after the sleep unit command, a query repeat command that indicates a zero count of query repeat commands transmitted since the query command. The method may include transmitting one or more other query repeat commands that each indicate a count of query repeat commands transmitted since the query command. The method may include monitoring for responses from the one or more other devices.

Some aspects described herein relate to a method of wireless communication performed by a second wireless device. The method may include receiving, from a first wireless device, a query command that includes a query parameter assigned to one or more second wireless devices and that requests a response from each of the one or more second wireless devices. The method may include receiving, from the first wireless device, a sleep unit command that is associated with a sleep unit duration of the second wireless device. The method may include receiving, after the sleep unit duration following the sleep unit command, a query repeat command that indicates a zero count of query repeat commands transmitted since the query command.

Some aspects described herein relate to a first wireless device. The first wireless device may include a processing system. The processing system may include one or more processors and one or more code-storing memories coupled with the one or more processors. The processing system may be configured to cause the first wireless device to transmit a query command that includes a query parameter assigned to one or more second wireless devices and that requests a response from each of the one or more second wireless devices. The processing system may be configured to cause the first wireless device to transmit a sleep unit command that is associated with sleep unit durations for the one or more second wireless devices. The processing system may be configured to cause the first wireless device to transmit, a sleep unit duration after the sleep unit command, a query repeat command that indicates a zero count of query repeat commands transmitted since the query command. The processing system may be configured to cause the first wireless device to transmit one or more other query repeat commands that each indicate a count of query repeat commands transmitted since the query command. The processing system may be configured to cause the first wireless device to monitor for responses from the one or more second wireless devices.

Some aspects described herein relate to a second wireless device. The second wireless device may include a processing system. The processing system may include one or more processors and one or more code-storing memories coupled with the one or more processors. The processing system may be configured to cause the second wireless device to receive, from a first wireless device, a query command that includes a query parameter assigned to one or more second wireless devices and that requests a response from each of the one or more second wireless devices. The processing system may be configured to cause the second wireless device to receive, from the first wireless device, a sleep unit command that is associated with a sleep unit duration of the second wireless device. The processing system may be configured to cause the second wireless device to receive, after the sleep unit duration following the sleep unit command, a query repeat command that indicates a zero count of query repeat commands transmitted since the query command.

Some aspects described herein relate to a non-transitory computer-readable medium that stores a set of instructions for wireless communication by a first wireless device. The set of instructions, when executed by one or more processors of the first wireless device, may cause the first wireless device to transmit a query command that includes a query parameter assigned to one or more second wireless devices and that requests a response from each of the one or more second wireless devices. The set of instructions, when executed by one or more processors of the first wireless device, may cause the first wireless device to transmit a sleep unit command that is associated with sleep unit durations for the one or more second wireless devices. The set of instructions, when executed by one or more processors of the first wireless device, may cause the first wireless device to transmit, a sleep unit duration after the sleep unit command, a query repeat command that indicates a zero count of query repeat commands transmitted since the query command. The set of instructions, when executed by one or more processors of the first wireless device, may cause the first wireless device to transmit one or more other query repeat commands that each indicate a count of query repeat commands transmitted since the query command. The set of instructions, when executed by one or more processors of the first wireless device, may cause the first wireless device to monitor for responses from the one or more other devices.

Some aspects described herein relate to a non-transitory computer-readable medium that stores a set of instructions for wireless communication by a second wireless device. The set of instructions, when executed by one or more processors of the second wireless device, may cause the second wireless device to receive, from a first wireless device, a query command that includes a query parameter assigned to one or more second wireless devices and that requests a response from each of the one or more second wireless devices. The set of instructions, when executed by one or more processors of the second wireless device, may cause the second wireless device to receive, from the first wireless device, a sleep unit command that is associated with a sleep unit duration of the second wireless device. The set of instructions, when executed by one or more processors of the second wireless device, may cause the second wireless device to receive, after the sleep unit duration following the sleep unit command, a query repeat command that indicates a zero count of query repeat commands transmitted since the query command.

Some aspects described herein relate to an apparatus for wireless communication. The apparatus may include means for transmitting a query command that includes a query parameter assigned to one or more other apparatuses and that requests a response from each of the one or more apparatuses. The apparatus may include means for transmitting a sleep unit command that is associated with sleep unit durations for the one or more apparatuses. The apparatus may include means for transmitting, a sleep unit duration after the sleep unit command, a query repeat command that indicates a zero count of query repeat commands transmitted since the query command. The apparatus may include means for transmitting one or more other query repeat commands that each indicate a count of query repeat commands transmitted since the query command. The apparatus may include means for monitoring for responses from the one or more other apparatuses.

Some aspects described herein relate to an apparatus for wireless communication. The apparatus may include means for receiving, from another apparatus, a query command that includes a query parameter assigned to one or more apparatuses and that requests a response from each of the one or more apparatuses. The apparatus may include means for receiving, from the other apparatus, a sleep unit command that is associated with a sleep unit duration of the apparatus. The apparatus may include means for receiving, after the sleep unit duration following the sleep unit command, a query repeat command that indicates a zero count of query repeat commands transmitted since the query command.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment of a system of Internet-of-Things (IoT) devices.

FIG. 2 is a diagram illustrating example components of a device.

FIG. 3 is a diagram illustrating an example associated with querying devices.

FIG. 4 is a diagram illustrating an example of using a sleep unit command for clock synchronization.

FIG. 5 is a diagram illustrating an example of managing a wake time of devices.

FIG. 6 is a flowchart of an example process associated with synchronization of IoT device responses.

FIG. 7 is a flowchart of an example process associated with query commands that indicate a count.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

In radio-frequency identification (RFID) systems, managing device (e.g., RFID tag) populations during inventory rounds is an integral part of the process. The Query command and QueryRep (query repetition) commands are fundamental in this context, with the Query command initiating an inventory round and the QueryRep command continuing the process. These commands are designed to regulate the responses of tags within the reader's range to avoid signal collisions, which are a common challenge in RFID communication.

During an inventory round initiated by a Query command with a specific Q-parameter, tags respond based on random numbers the tags generate, which affects when the tags communicate back to the reader. This method is intended to singulate tags for efficient identification and acknowledgment. However, this approach requires tags to remain awake throughout the inventory round to receive and respond to QueryRep commands, which can lead to increased energy consumption for the tags, especially those with higher Q-parameter values that would wait longer to respond.

The necessity for tags to stay active and continuously decrement their counters with each QueryRep command consumes energy, particularly for semi-passive and active RFID tags. These tags, unlike their passive counterparts, possess an internal clock enabling them to operate on a duty cycle basis, allowing for sleep mechanisms to save power. However, the current system does not adequately support such energy-saving capabilities during inventory rounds.

Moreover, the existing structure of QueryRep commands does not sufficiently accommodate the need for tags to go into a sleep state and then wake up at the right time to scan for reader commands, which could help in reducing energy consumption. This limitation is a significant concern as it impacts the efficiency and longevity of RFID systems and IoT devices, where the IoT devices may benefit from sleep mechanisms during inventory processes.

Various aspects relate generally to enhancing the efficiency of inventory rounds for IoT devices and RFID systems. Some aspects more specifically relate to a method performed by a first wireless device (e.g., reader/transmitter), which may include transmitting a query command with a query parameter to one or more second wireless devices (e.g., IoT devices), requesting a response. The first wireless device may transmit a sleep unit command associated with sleep unit durations for these devices, followed by a query repeat command indicating a zero count of query repeat commands since the query command. The first wireless device may also monitor for responses. The method may further include transmitting additional query repeat commands, each indicating the count of query repeat commands transmitted since the query command, and receiving responses from the second wireless devices.

In some aspects, the sleep unit command may have a format specific to indicating the sleep unit duration or may have a query repeat command format with one or more invalid query repeat command values. The method allows for second wireless devices to receive these commands, determine the quantity of clock cycles in the sleep unit duration, and sleep for a total sleep duration based on the query parameter and the quantity of clock cycles in the sleep unit duration. The second wireless devices may wake up at the end of the total sleep duration, receive a query repeat command with a count of query repeat commands transmitted since a query command, decrement a current value of a counter based on the count in the query repeat command, and transmit a response based on the counter satisfying a threshold count value. Additional behaviors include scaling the sleep unit duration down based on a maximum clock error value, returning to sleep or remaining awake based on a threshold difference between the query parameter and a count in a received query repeat command, and transmitting a response message or waiting for the next query repeat command based on the counter for the second wireless device.

Particular aspects of the subject matter described in this disclosure can be implemented to realize one or more of the following potential advantages. By incorporating sleep unit durations and dynamic sleep management, the described techniques can significantly reduce power consumption and extend the operational life of battery-powered IoT devices. The optimization of sleep and wake-up cycles based on precise timing and clock cycle management minimizes energy expenditure during non-critical periods, thereby conserving battery resources. Furthermore, the dynamic adjustment of sleep durations to account for clock inaccuracies ensures synchronized operation within the RFID system, which enhances the reliability of communication and inventory accuracy. The benefits include improved resource allocation and reduction in the need for frequent battery replacement or recharging, leading to a more sustainable and cost-effective deployment of RFID technology in inventory management systems. In this way, the solution may conserve energy resources and reduce operational costs associated with maintaining active RFID systems.

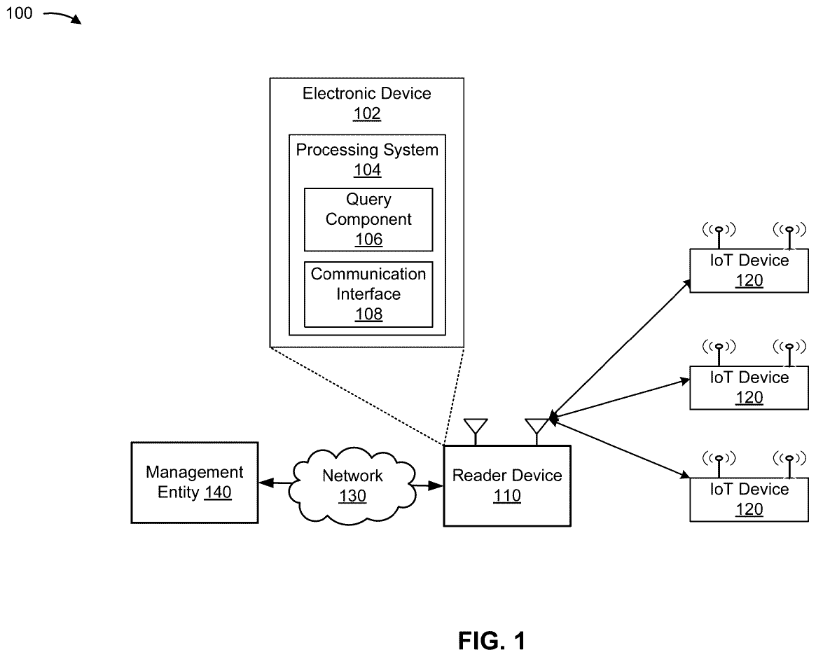

FIG. 1 is a diagram illustrating an example environment of a system of IoT devices. The system of IoTs in FIG. 1 may include IoT devices 120 (e.g., an ambient IoT (A-IoT) device, electronic shelf label (ESL) devices, RFIDs for commercial or residential inventory) that can be inventoried by a reader device 110 (e.g., access point (AP)). The reader device 110 may assist in the management and control of the entire system and all of the interconnected devices. The reader device 110 and other devices may be configured to communicate with network entities via a network 130 that is wire-based or wireless, and may include a backhaul.

The IoT devices may include A-IoT devices that obtain energy from a source other than an on-device battery. This may include obtaining energy from a source outside of the device. Devices that use energy harvesting may have a small energy storage device or battery (e.g., smart watch, RedCap devices, eRedCap devices) or no energy storage device or battery (e.g., zero-power devices, ambient IoT devices, RFID tags wearables, or financial devices). Energy harvesting may include converting RF energy transferred from another device. The harvesting of RF energy may not fully charge a battery but may be used for some tasks like data decoding, operating some filters, data reception, data encoding, and/or data transmission. For example, an RF receiver (e.g., an IoT device 120) may receive signals (e.g., radio signals carried on radio waves) from an RF transmitter (e.g., a reader device 110 or a user equipment (UE)) and convert electromagnetic energy of the signals (e.g., using a rectenna comprising a dipole antenna with an RF diode) into direct current electricity for use by the RF receiver. The RF receiver may be a low-power device or a zero-power device. The RF transmitter may be referred to as a “charging device.”

A-IoT devices may rely on passive communication technologies, such as backscatter communication. Backscatter communication involves using an RF signal to write or transmit data without a battery or a power source. A transmitter/reader may be an RF source that transmits a continuous wave (CW) signal. The A-IoT device may harvest energy (e.g., tens or hundreds of microwatts of electricity) from the signal and use passive reflection and modulation of the signal to transmit a backscatter signal using the harvested energy. That is, the A-IoT device may modulate the signal to encode data and then reflect a fraction of the wave to the reader device or to the transmitter/reader. The backscatter signal may be encoded with information bits (e.g., identifying information, sensor information). The reader device 110 may receive the backscatter signal and read the information bits. In some scenarios, there may be multiple readers that provide continuous coverage to a location, such as a whole store/warehouse.

A-IoT devices may be categorized according to A-IoT device types. In some aspects, an A-IoT device of type A may have no energy storage and no independent signal generation (i.e., backscattering transmission). An A-IoT device of type A may have no passive filtering capability, and thus a transmitting device may not transmit a signal to different devices at the same time. An A-IoT device of type B may have energy storage but no independent signal generation (i.e., backscattering transmission). An A-IoT device of type A or an A-IoT device of type B may have no energy to maintain a clock (e.g., preconfiguring the monitoring occasion for a downlink signal may not work). The use of stored energy may include amplification for reflected signals. An A-IoT device of type C may have energy storage and independent signal generation (i.e., active RF component for transmission). An A-IoT device of type B or type C may have energy to maintain the clock, but the clock stability may be imprecise.

In some aspects, A-IoT devices or A-IoT device types may be placed into groups. Groups (grouping 1) may include a group for indoor devices, a group for outdoor devices, and a group for both indoor/outdoor devices. Other groups (grouping B) may include a group of inventory devices, a group of sensors, a group of positioning devices, or a group of command devices. Grouping A and grouping B may be separate or together (e.g., group first by A, and second by B).

The reader device 110 and IoT devices 120 may use transceiver circuitry that includes at least one transmitter and at least one receiver. The coupling shown for the system (e.g. between an IoT device 120 and the reader device 110) is wireless and bidirectional. However, other coupling methods such as hard wiring (or a hybrid combination of the two coupling methods or mechanisms working together) can be used, without deviating from the devices, methods, spirit, and scope disclosed herein. A management entity 140 (e.g., central control unit) may provide control and processing, as well as other functionality used to support and implement the system. The management entity 140 may also implement a supervisory or master role within the communication network.

Each of the reader device 110, an IoT device 120, and the management entity 140 may be an electronic device 102. The electronic device 102 includes one or more devices capable of establishing a secure connection. For example, the electronic device 102 may include a wired and/or wireless communication and/or computing device, such as an access point, a station, a mobile phone, a UE, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The reader device 110 may include one or more devices (e.g., electronic device 102) capable of receiving, processing, storing, routing, and/or providing traffic (e.g., a packet and/or other information or metadata) in a manner described herein. For example, the reader device 110 may include or may be coupled to a router, such as a label switching router (LSR), a label edge router (LER), an ingress router, an egress router, a provider router (e.g., a provider edge router or a provider core router), a virtual router, or another type of router. Additionally, or alternatively, the reader device 110 may include or may be coupled to a gateway, a switch, a firewall, a hub, a bridge, a reverse proxy, a server (e.g., a proxy server, a cloud server, or a data center server), a load balancer, and/or a similar device. Additionally, or alternatively, other network nodes may connect with the reader device 110 or the IoT devices 120. A network node may include a base station (a Node B, an eNB, and/or a gNB, among other examples), a relay device, a network controller, a transmit receive point (TRP), an apparatus, a device, a computing system, one or more components of any of these, and/or another processing entity configured to perform one or more aspects of the techniques described herein. For example, the network node may be an aggregated base station and/or one or more components of a disaggregated base station (e.g., a central unit (CU), a distributed unit (DU), and/or a radio unit (RU), also known as a remote radio unit (RRU) or remote radio head (RRH)). The reader device 110 may operate as a network node. In some aspects, the reader device 110 may be a physical device implemented within a housing, such as a chassis. In some aspects, the reader device 110 may be a virtual device implemented by one or more computing devices of a cloud computing environment or a data center. In some aspects, a group of network nodes may be a group of data center nodes that are used to route traffic flow through a network.

The management entity 140 may include one or more devices (e.g., electronic device 102) capable of providing services related to a user state and/or a user intent associated with the electronic device. For example, the management entity 140 may include a wired and/or wireless communication and/or computing device, such as a UE, wireless or mobile station, a mobile phone (e. g., a smart phone, a radiotelephone, and/or the like), a laptop computer, a tablet computer, a handheld computer, a desktop computer, a gaming device, a wearable communication device (e.g., a smart wristwatch or a pair of smart eyeglasses), or the like. Additionally, or alternatively, the management entity 140 may include a server, such as an application server, a client server, a web server, a database server, a host server, a proxy server, a virtual server (e.g., executing on computing hardware), or a server in a cloud computing system. In some aspects, the management entity 140 may include computing hardware used in a cloud computing environment.

The network 130 includes one or more wired and/or wireless networks. For example, the network 130 may include a cellular network (e.g., a code division multiple access (CDMA) network, a 3G network, a 4G network, a 5G network, a 6G network, or another type of next generation network, or the like), a public land mobile network (PLMN), a local area network (LAN) or a wireless LAN (WLAN), a wide area network (WAN) or a wireless WAN (WWAN), a personal area network (PAN) or a wireless PAN (WPAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

As shown, the electronic device 102 may include a processing system 104. The processing system 104 may include one or more components (or subcomponents), such as a query component 106, a communication interface 108, and/or one or more other components described herein. For example, a component of the processing system 104 may be, be similar to, include, or be included in at least one memory, at least one communication interface, or at least one processor. The processing system 104 may generally correspond to a system that includes one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, as shown in FIG. 1, the processing system 104 may include the query component 106, which may be configured to perform one or more tasks or operations described herein. In some aspects, the query component 106 may direct the communication interface 108 to perform one or more communication tasks as described herein. Although depicted with reference only to the electronic device 102, any one or more of the IoT devices 120 and/or the management entity 140 may include a communication interface.

As used herein, the communication interface 108 may be any suitable interface that enables communication (e.g., wireless communication, wired communication, or a combination thereof) between the electronic device 102 and another entity or device, such as the IoT devices 120. The communication interface 108 may include electronic circuitry that enables the electronic device 102 to transmit, receive, or otherwise perform the communication. For example, the communication interface 108 may include a transmission component, a reception component, and/or a transceiver configured to communicate with other devices, such as via a wired connection, a wireless connection, or a combination of wired and wireless connections. In some examples, the communication interface 108 may include one or more RF components, an RF front end, one or more antennas, one or more transmit or receive processors, a demodulation component, and/or a modulation component, among other examples. In some examples, the communication interface 108 may include an Ethernet interface, an optical interface, a coaxial interface, an infrared interface, a radio frequency (RF) interface, a universal serial bus (USB) interface, a Wi-Fi interface, a cellular network interface, a wireless modem, a short-range wireless interface, a Bluetooth interface, an inter-integrated circuit (I2C), and/or a serial peripheral interface (SPI), among other examples.

As described in more detail elsewhere herein, the electronic device 102 may be a first wireless device, such as reader device 110, and may (e.g., using the processing system 104 may, or the processing system 104) cause the query component 106 and/or the communication interface 108 to provide, from a host of the first wireless device to a controller of the first wireless device, a generate key command that includes one or more coordinates for encryption and a connection handle associated with a connection between the first wireless device and a second wireless device (e.g., IoT device 120) that operates with a low energy wireless protocol. Additionally, or alternatively, the electronic device 102 and/or the query component 106 may perform one or more other operations described herein.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment may perform one or more functions described as being performed by another set of devices of the environment.

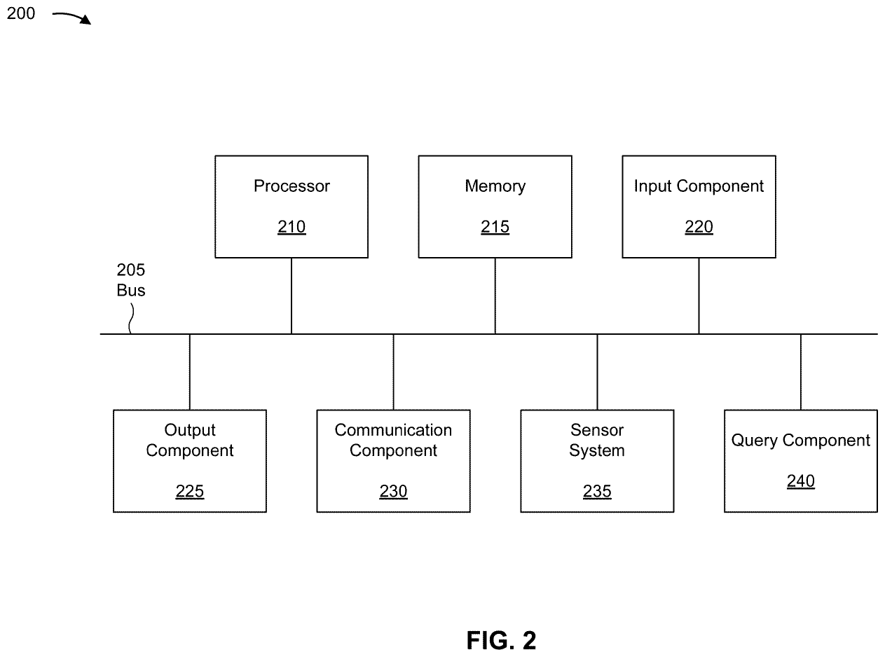

FIG. 2 is a diagram illustrating example components of a device 200. The device 200 may correspond to an electronic device 102, such as the reader device 110, an IoT device 120, and/or the management entity 140. In some aspects, the electronic device 102, the reader device 110, and/or the management entity 140 may include one or more devices 200 and/or one or more components of the device 200. As shown in FIG. 2, the device 200 may include a bus 205, a processor 210, a memory 215, an input component 220, an output component 225, a communication component 230, a sensor system 235, and/or a query component 240.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, and/or an antenna.

The sensor system 235 includes one or more wired or wireless devices capable of receiving, generating, storing, transmitting, processing, detecting, and/or providing information associated with a state of the device 200 and/or an environment surrounding the device 200, as described elsewhere herein. For example, the sensor system 235 may include a motion sensor, an accelerometer, a gyroscope, an inertial measurement unit (IMU), a proximity sensor, a light sensor, a noise sensor, a pressure sensor, an ultrasonic sensor, a positioning sensor, a capacitive sensor, a timing device, an infrared sensor, an active sensor (e.g., a sensor that uses external power), a passive sensor (e.g., a sensor that does not need external power), a biological or biometric sensor, a smoke sensor, a gas sensor, a chemical sensor, an alcohol sensor, a temperature sensor, a moisture sensor, a humidity sensor, a radioactive sensor, a magnetometer, a hall sensor, an electromagnetic sensor, an analog sensor, and/or a digital or virtual sensor (e.g., a software-based sensor, or algorithm, that gathers data from one or more physical hardware sensors and generates an intended sensor output), among other examples. The sensor system 235 may sense or detect a condition or information related to a state of the device 200 and/or an environment surrounding the device 200 and transmit, using a wired or wireless communication interface, an indication of the detected condition or information to other components of the device 200 and/or other devices.

The query component 240 includes one or more devices capable of receiving, generating, storing, transmitting, processing, detecting, and/or providing security keys and related commands, as described elsewhere herein. For example, in some aspects, the query component 240 may provide, from a host of a first wireless device (e.g., device 200) to a controller of the first wireless device, a generate key command that includes one or more coordinates for encryption and a connection handle associated with a connection between the first wireless device and a second wireless device (e.g., device 200) that operates with a low energy wireless protocol; generate, at the controller, a security key based at least in part on the one or more coordinates and the connection handle; provide the security key from the controller to the host; and transmit, from the controller, a check value for the security key to the second wireless device in association with establishing the connection. Additionally, or alternatively, the query component 240 may perform other operations described herein.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, the device 200 may be a first wireless device and may include means for transmitting a query command that includes a query parameter assigned to one or more second wireless devices and that requests a response from each of the one or more second wireless devices; means for transmitting a sleep unit command that is associated with sleep unit durations for the one or more second wireless devices; means for transmitting, a sleep unit duration after the sleep unit command, a query repeat command that indicates a zero count of query repeat commands transmitted since the query command; means for transmitting one or more other query repeat commands that each indicate a count of query repeat commands transmitted since the query command; or means for monitoring for responses from the one or more other devices. In some aspects, the means for the first wireless device to perform operations described herein may include, for example, one or more of processor 210, memory 215, communication component 230, and query component 240.

In some aspects, the device 200 may be a second wireless device includes means for receiving, from a first wireless device, a query command that includes a query parameter assigned to one or more second wireless devices and that requests a response from each of the one or more second wireless devices; means for receiving, from the first wireless device, a sleep unit command that is associated with a sleep unit duration of the second wireless device; or means for receiving, after the sleep unit duration following the sleep unit command, a query repeat command that indicates a zero count of query repeat commands transmitted since the query command. In some aspects, the means for the second wireless device to perform operations described herein may include one or more of processor 210, memory 215, communication component 230, and query component 240.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

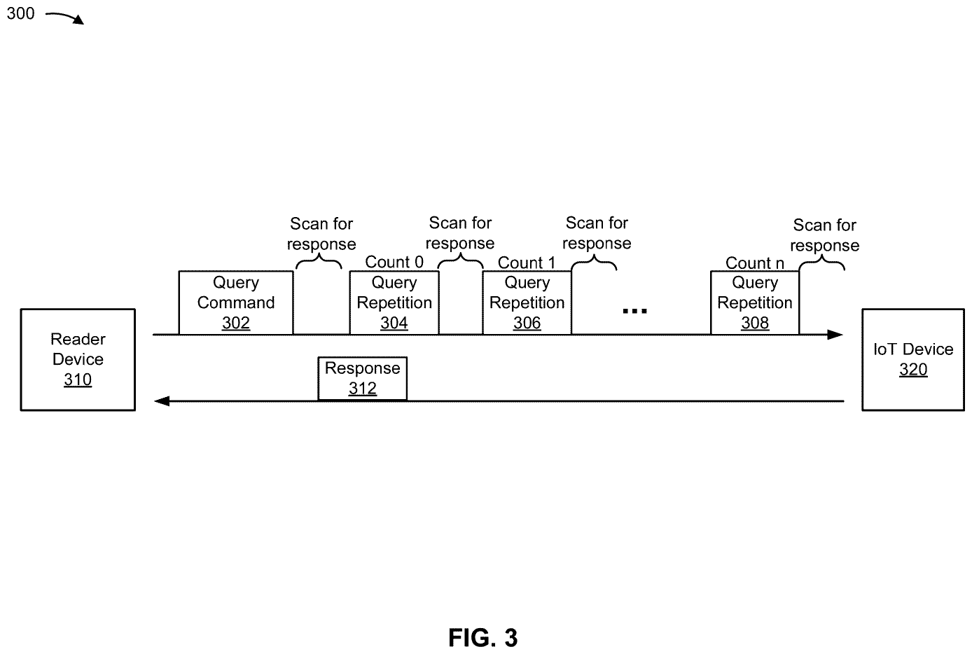

FIG. 3 is a diagram illustrating an example 300 associated with querying devices. As shown in FIG. 3, a wireless device, such as a reader device 310 (e.g., electronic device 102, AP) and a wireless station (e.g., electronic device 102, IoT device 120 such as an ESL device or an RFID) may communicate with one another.

In RFID systems, a transmitter/reader (e.g., reader device 310) may use query commands and query repetition commands to manage tag populations during inventory rounds. A query command 302 may initiate an inventory round. The reader device 310 may transmit the query command 302 to identify tags within its range, such as IoT device 320. The query command 302 may include a query parameter (Q-parameter), which helps in managing how many tags respond at once to avoid collisions. Different IoT devices or groups of IoT devices can have different Q-parameter values. The reader device 310 may continue the inventory process after the initial query command 302 by transmitting additional query repetitions commands, such as query repetitions 304, 306, and 308. The reader device 310 may scan for a response after each query repetition. The IoT device 320 may transmit a response 312 based on its Q-parameter. The query repetitions help to obtain responses from tags that were not identified in the first round with the initial query command 302.

For example, the reader device 310 may issue a query command with a parameter of Q=4. The IoT devices (e.g., tags) generate two random numbers, the first one is a random 16-bit identifier (ID), and the second ranging from zero and 2 to the power of Q, minus 1. If Q is 4, then 2 to the fourth power is 16, minus 1 equals 15. So all tags select a second random number ranging from zero and 15. The reader device 310 requests that any tag that selects zero for their second random number to respond. If one tag has zero, then the tag responds with the first random number, and the reader acknowledges the response. Since the tag has been singulated, the reader device 310 may simply count the tag as present.

Then, the reader device 310 asks the remaining tags to subtract one from their second random number and singulates the next tag that has a zero. The reader device 310 continues doing so until all of the tags are singulated.

If no tags select zero for their first random number, then the reader device 310 asks all of the tags to decrement their random number by one. The reader device 310 continues until a tag with a zero count responds. With passive RFID tags, before the reader device 310 transmits a command, the reader device 310 will energize the tags to be able to decode its command. However, waking the tags up too often consumes excess power.

In many scenarios, the overall range of the inventory process is short, and a tag does not need to maintain any notion of timing between the different transmissions of the reader device 310. However, the current assumption for semi-passive and active RFID is that the tags can assume duty cycle-based operation. That is, the tags have an internal clock that gives some notion of time to the system and hence the tags can save their power by performing some sleep mechanisms. However, there is not an effective system as the device clocks may fall out of synchronization with the clock of the reader device 310, causing the tags to miss response occasions and waste power.

As indicated above, FIG. 3 is provided as an example. Other examples may differ from what is described with respect to FIG. 3.

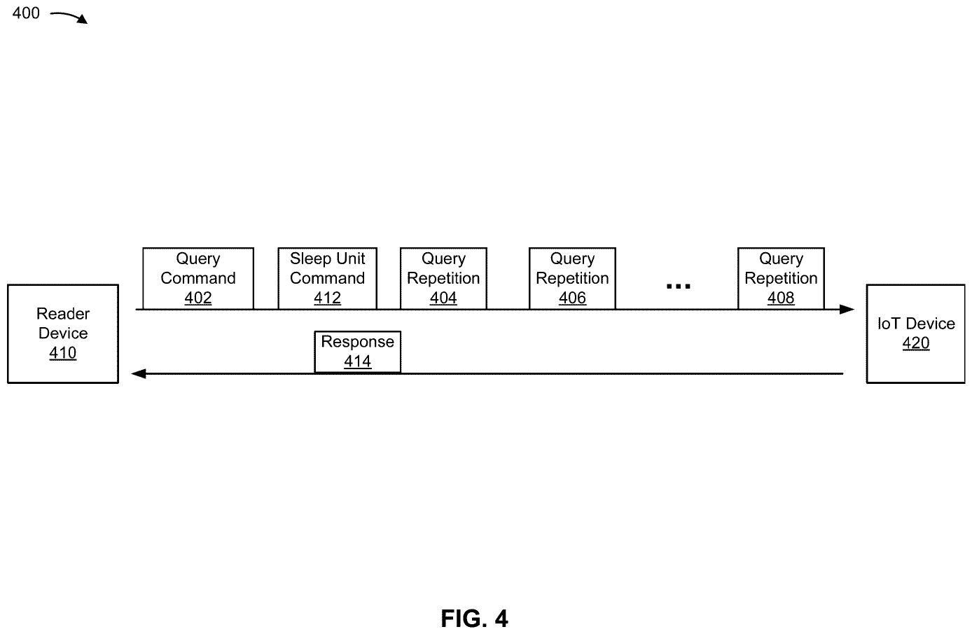

FIG. 4 is a diagram illustrating an example 400 of using a sleep unit command for clock synchronization.

Example 400 shows a first wireless device, such as reader device 410, and a second wireless device, such as an IoT device 420. The reader device 410 may transmit a query command 402 that includes a Q-parameter assigned to one or more IoT devices. The query command 402 requests a response from IoT devices. Subsequently, the reader device 410 may transmit a sleep unit command 412, which has a format specific to indicating sleep unit durations for IoT devices. The format of the sleep unit command 412 may follow a query repeat command format with one or more invalid query repeat command values to ensure that the reader device 410 is uniquely identifiable by capable devices, while being ignored by legacy devices.

The sleep unit command 412 may follow the query command 402 by a sleep unit duration, signifying an amount of time that is equal to a number of clock cycles of the IoT device 420. The sleep unit duration may be used to capture the relative local clock error between the reader device 410 and the IoT device 420. The sleep unit command 412 is recognized by IoT devices capable of sleep unit calibration, and not recognized by legacy devices. The sleep unit command 412 does not have to be acknowledged. There may be time periods for message exchanges 506 and 510 that follow the query repetitions.

After the sleep unit command 412, the reader device 410 may transmit a series of query repetitions 404, 406, and 408. The reader device 410 may monitor for responses from IoT devices and receive one or more responses, such as response 414 from the IoT device 420. The IoT device 420 may sleep and then wake up for the query repetitions based on the synchronization of the clock cycles of the IoT device 420. The IoT device 420 may count the clock cycles. The IoT device 420 may take into account its expected clock jitter but not the clock frequency offset, as this offset is already captured by the cycle counting process. In this way, the IoT device 420 wakes up at the right time to receive a query repetition and provide a response based on the Q-parameter of the IoT device 420. As a result, the IoT device 420 conserves power by not falling out of synchronization with the query repetitions and waking up at the wrong times to miss query repetitions.

In some aspects, the IoT device 420 may scale the sleep unit duration down based on a maximum clock error value. This can help to adjust the number of clock cycles for a sleep unit duration, for better synchronization. For example, if it is expected that there is a maximum clock error of x%, then the IoT device 420 may expect a conservative approach and scale the sleep duration by a factor of (1-x/100). That is, the IoT device 420 may expect that its clock is slower than a reader clock, to ensure that the IoT device 420 wakes up before its intended time. Additional scaling may be used as a safety margin to ensure that the IoT device 420 wakes up and does not miss its triggering query repetition.

As indicated above, FIG. 4 is provided as an example. Other examples may differ from what is described with regard to FIG. 4.

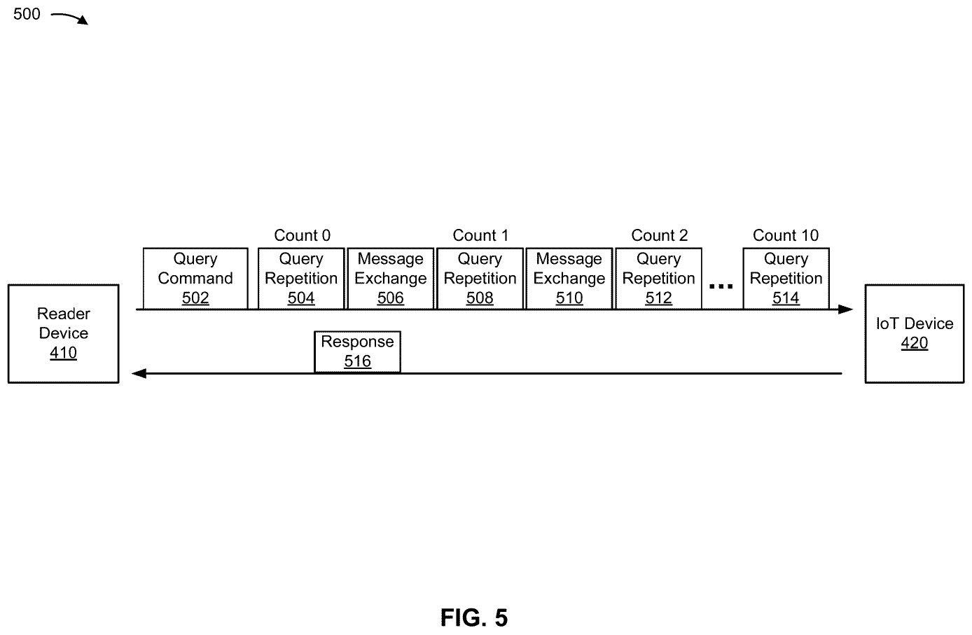

FIG. 5 is a diagram illustrating an example 500 of managing a wake time of devices.

In some scenarios, the IoT device wakes up for every query repetition, which consumes power and processing resources. In some aspects, the query repetition may indicate a count of how many query repetition commands have been transmitted since the initial query command 502. Each IoT device may wake up for a particular query repetition and not all of them. For example, query repetition 504 may be the first query repetition command and indicates a count of zero, query repetition 508 may have a count of one, query repetition 512 may have a count of two, and so on. Query repetition 514 shows a count of ten. An IoT device may transmit a response when a counter is zero or wait for a next query repetition to respond.

The IoT device 420 may sleep and then wake up for one of these query repetitions (or more) but not all of the query repetitions. The IoT device 420 may wake up based on the Q-parameter and provide a response 516. The IoT device 420 may wake up at a multiple of the sleep unit duration, counting the total number of clock cycles (number of clock cycles of the sleep unit duration times the Q-parameter).

In some aspects, if the IoT device's counter is zero, the IoT device may respond with a random ID. The reader device 410 may then transmit an acknowledgement (ACK) and the tag respond with its ID or electronic product code (EPC). If no IoT device has a counter of zero, the reader device 410 may transmit the next query repetition.

The IoT device 420 may return to sleep (for another sleep unit duration or for a modified duration) based on a difference between the Q-parameter and a count in a received query repeat command satisfying a difference threshold, or remain awake if the difference does not satisfy the difference threshold.

The reader device 410 may wait for a response or message exchange after each query repetition, such as shown by message exchange 506 or message exchange 510. After a time threshold without receiving a response, the reader device 410 may transmit a next query repetition according to the sleep unit duration and the Q-parameter values of the IoT devices. To determine a sleep time, an IoT device may expect that no other devices will respond for the query repetitions and may count for the back-to-back transmission durations of query repetitions with the readers scanning time only. The number of query repetitions may be based on the Q-parameter values.

There may be a scenario where an IoT device wakes up and the first query repetition that is received and decoded successfully has with a count higher than a Q-parameter of the IoT device. For example, the IoT device 420 may wake up for a query repetition of count 10. In some aspects, the IoT device 420 may reduce its counter to zero and directly respond to the reader device 410, or not respond and wait until the next query repetition. This determination may be based at least in part on the difference between the count and the Q-parameter of the IoT device 420. For example, the IoT device 420 may not respond and wait if the difference is greater than a difference threshold. Otherwise, the IoT device 420 may respond. By indicating a count in the query repetition, the IoT devices can avoid waking up more than necessary and conserve power.

As indicated above, FIG. 5 is provided as an example. Other examples may differ from what is described with regard to FIG. 5.

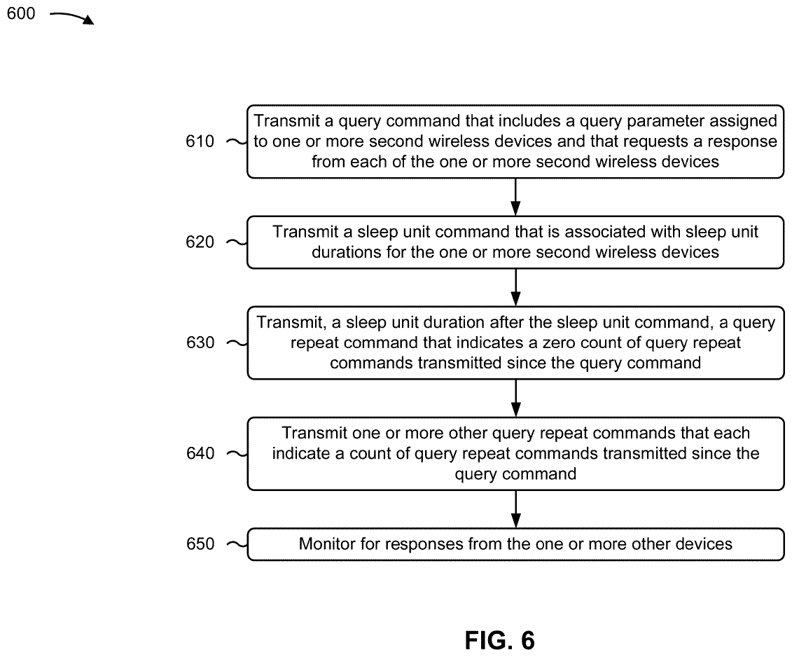

FIG. 6 is a flowchart of an example process 600 associated with synchronization of IoT responses, in accordance with the present disclosure. In some aspects, one or more process blocks of FIG. 6 are performed by a first wireless device (e.g., reader device 410). In some aspects, one or more process blocks of FIG. 6 are performed by another device or a group of devices separate from or including the first wireless device. Additionally, or alternatively, one or more process blocks of FIG. 6 may be performed by one or more components of device 200, such as processor 210, memory 215, input component 220, output component 225, communication component 230, sensor system 235, and/or query component 240.

As shown in FIG. 6, process 600 may include transmitting a query command that includes a query parameter assigned to one or more second wireless devices and that requests a response from each of the one or more second wireless devices (block 610). For example, the first wireless device may transmit a query command that includes a query parameter assigned to one or more second wireless devices and that requests a response from each of the one or more second wireless devices, as described above.

As further shown in FIG. 6, process 600 may include transmitting a sleep unit command that is associated with sleep unit durations for the one or more second wireless devices (block 620). For example, the first wireless device may transmit a sleep unit command that is associated with sleep unit durations for the one or more second wireless devices, as described above.

As further shown in FIG. 6, process 600 may include transmitting, a sleep unit duration after the sleep unit command, a query repeat command that indicates a zero count of query repeat commands transmitted since the query command (block 630). For example, the first wireless device may transmit, a sleep unit duration after the sleep unit command, a query repeat command that indicates a zero count of query repeat commands transmitted since the query command, as described above.

As further shown in FIG. 6, process 600 may include transmitting one or more other query repeat commands that each indicate a count of query repeat commands transmitted since the query command (block 640). For example, the first wireless device may transmit one or more other query repeat commands that each indicate a count of query repeat commands transmitted since the query command, as described above.

As further shown in FIG. 6, process 600 may include monitoring for responses from the one or more other devices (block 650). For example, the first wireless device may monitor for responses from the one or more other devices, as described above.

Process 600 may include additional aspects, such as any single aspect or any combination of aspects described below and/or in connection with one or more other processes described elsewhere herein.

In a first aspect, process 600 includes receiving one or more responses from the one or more second wireless devices.

In a second aspect, alone or in combination with the first aspect, the sleep unit command has a format specific to indicating the sleep unit duration.

In a third aspect, alone or in combination with one or more of the first and second aspects, the sleep unit command has a query repeat command format and one or more invalid query repeat command values.

Although FIG. 6 shows example blocks of process 600, in some aspects, process 600 includes additional blocks, fewer blocks, different blocks, or differently arranged blocks than those depicted in FIG. 6. Additionally, or alternatively, two or more of the blocks of process 600 may be performed in parallel.

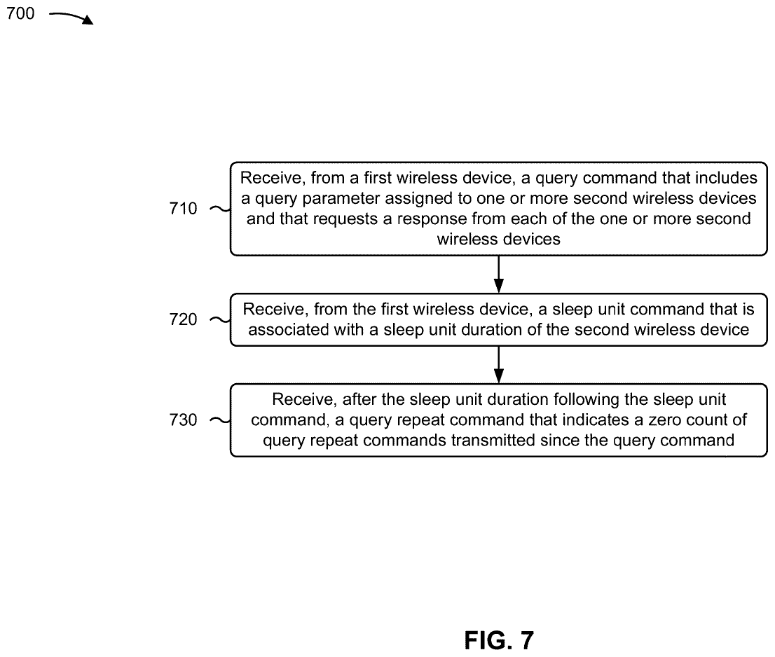

FIG. 7 is a flowchart of an example process 700 associated with query commands that indicate a count, in accordance with the present disclosure. In some aspects, one or more process blocks of FIG. 7 are performed by a second wireless device (e.g., IoT device 420). In some aspects, one or more process blocks of FIG. 7 are performed by another device or a group of devices separate from or including the second wireless device. Additionally, or alternatively, one or more process blocks of FIG. 7 may be performed by one or more components of device 200, such as processor 210, memory 215, input component 220, output component 225, communication component 230, sensor system 235, and/or query component 240.

As shown in FIG. 7, process 700 may include receiving, from a first wireless device, a query command that includes a query parameter assigned to one or more second wireless devices and that requests a response from each of the one or more second wireless devices (block 710). For example, the second wireless device may receive, from a first wireless device, a query command that includes a query parameter assigned to one or more second wireless devices and that requests a response from each of the one or more second wireless devices, as described above.

As further shown in FIG. 7, process 700 may include receiving, from the first wireless device, a sleep unit command that is associated with a sleep unit duration of the second wireless device (block 720). For example, the second wireless device may receive, from the first wireless device, a sleep unit command that is associated with a sleep unit duration of the second wireless device, as described above.

As further shown in FIG. 7, process 700 may include receiving, after the sleep unit duration following the sleep unit command, a query repeat command that indicates a zero count of query repeat commands transmitted since the query command (block 730). For example, the second wireless device may receive, after the sleep unit duration following the sleep unit command, a query repeat command that indicates a zero count of query repeat commands transmitted since the query command, as described above.

Process 700 may include additional aspects, such as any single aspect or any combination of aspects described below and/or in connection with one or more other processes described elsewhere herein.

In a first aspect, process 700 includes determining a quantity of clock cycles in the sleep unit duration.

In a second aspect, alone or in combination with the first aspect, process 700 includes sleeping for a total sleep duration that is based at least in part on the query parameter and the quantity of clock cycles in the sleep unit duration, and waking up at an end of the total sleep duration.

In a third aspect, alone or in combination with one or more of the first and second aspects, the total sleep duration is the query parameter times the sleep unit duration.

In a fourth aspect, alone or in combination with one or more of the first through third aspects, process 700 includes receiving, from the first wireless device, a query repeat command that indicates a count of query repeat commands transmitted since a query command, decrementing a current value of a counter of the second wireless device based at least in part on the count in the query repeat command, and transmitting a response based at least in part on the counter satisfying a threshold count value.

In a fifth aspect, alone or in combination with one or more of the first through fourth aspects, process 700 includes scaling the sleep unit duration down based at least in part on a maximum clock error value.

In a sixth aspect, alone or in combination with one or more of the first through fifth aspects, process 700 includes returning to sleep based at least in part on a difference between the query parameter and a count in a received query repeat command satisfying a difference threshold, or remaining awake based at least in part on the difference not satisfying the difference threshold.

In a seventh aspect, alone or in combination with one or more of the first through sixth aspects, process 700 includes transmitting a response message based at least in part on a counter for the second wireless device being zero, or waiting for a next query repeat command to respond.

Although FIG. 7 shows example blocks of process 700, in some aspects, process 700 includes additional blocks, fewer blocks, different blocks, or differently arranged blocks than those depicted in FIG. 7. Additionally, or alternatively, two or more of the blocks of process 700 may be performed in parallel.

The following provides an overview of some Aspects of the present disclosure:
Aspect 1: A method of wireless communication performed by a first wireless device, comprising: transmitting a query command that includes a query parameter assigned to one or more second wireless devices and that requests a response from each of the one or more second wireless devices; transmitting a sleep unit command that is associated with sleep unit durations for the one or more second wireless devices; transmitting, a sleep unit duration after the sleep unit command, a query repeat command that indicates a zero count of query repeat commands transmitted since the query command; transmitting one or more other query repeat commands that each indicate a count of query repeat commands transmitted since the query command; and monitoring for responses from the one or more other devices.
Aspect 2: The method of Aspect 1, further comprising receiving one or more responses from the one or more second wireless devices.
Aspect 3: The method of any of Aspects 1-2, wherein the sleep unit command has a format specific to indicating the sleep unit duration.
Aspect 4: The method of any of Aspects 1-3, wherein the sleep unit command has a query repeat command format and one or more invalid query repeat command values.
Aspect 5: A method of wireless communication performed by a second wireless device, comprising: receiving, from a first wireless device, a query command that includes a query parameter assigned to one or more second wireless devices and that requests a response from each of the one or more second wireless devices; receiving, from the first wireless device, a sleep unit command that is associated with a sleep unit duration of the second wireless device; and receiving, after the sleep unit duration following the sleep unit command, a query repeat command that indicates a zero count of query repeat commands transmitted since the query command.
Aspect 6: The method of Aspect 5, further comprising determining a quantity of clock cycles in the sleep unit duration.
Aspect 7: The method of Aspect 6, further comprising: sleeping for a total sleep duration that is based at least in part on the query parameter and the quantity of clock cycles in the sleep unit duration; and waking up at an end of the total sleep duration.
Aspect 8: The method of Aspect 7, wherein the total sleep duration is the query parameter times the sleep unit duration.
Aspect 9: The method of Aspect 7, further comprising: receiving, from the first wireless device, a query repeat command that indicates a count of query repeat commands transmitted since a query command; decrementing a current value of a counter of the second wireless device based at least in part on the count in the query repeat command; and transmitting a response based at least in part on the counter satisfying a threshold count value.
Aspect 10: The method of Aspect 7, further comprising scaling the sleep unit duration down based at least in part on a maximum clock error value.
Aspect 11: The method of Aspect 7, further comprising: returning to sleep based at least in part on a difference between the query parameter and a count in a received query repeat command satisfying a difference threshold, or remaining awake based at least in part on the difference not satisfying the difference threshold.
Aspect 12: The method of any of Aspects 5-11, further comprising: transmitting a response message based at least in part on a counter for the second wireless device being zero, or waiting for a next query repeat command to respond.
Aspect 13: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-12.
Aspect 14: An apparatus for wireless communication at a device, the apparatus comprising one or more memories and one or more processors coupled to the one or more memories, the one or more processors configured to cause the device to perform the method of one or more of Aspects 1-12.
Aspect 15: An apparatus for wireless communication, the apparatus comprising at least one means for performing the method of one or more of Aspects 1-12.
Aspect 16: A non-transitory computer-readable medium storing code for wireless communication, the code comprising instructions executable by one or more processors to perform the method of one or more of Aspects 1-12.
Aspect 17: A non-transitory computer-readable medium storing a set of instructions for wireless communication, the set of instructions comprising one or more instructions that, when executed by one or more processors of a device, cause the device to perform the method of one or more of Aspects 1-12.
Aspect 18: A device for wireless communication, the device comprising a processing system that includes one or more processors and one or more memories coupled with the one or more processors, the processing system configured to cause the device to perform the method of one or more of Aspects 1-12.
Aspect 19: An apparatus for wireless communication at a device, the apparatus comprising one or more memories and one or more processors coupled to the one or more memories, the one or more processors individually or collectively configured to cause the device to perform the method of one or more of Aspects 1-12.
Aspect 20: A device comprising a processing system that includes one or more processors and one or more code-storing memories coupled with the one or more processors, the processing system configured to cause the device to perform the method of one or more of Aspects 1-12.
Aspect 21: A device comprising a processing system that includes processor circuitry and code-storing memory circuitry, the processing system configured to cause the device to perform the method of one or more of Aspects 1-12.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first wireless device, comprising:
a processing system that includes one or more processors and one or more code-storing memories coupled with the one or more processors, the processing system configured to cause the first wireless device to:
transmit a query command that includes a query parameter assigned to one or more second wireless devices and that requests a response from each of the one or more second wireless devices;
transmit a sleep unit command that is associated with sleep unit durations for the one or more second wireless devices;
transmit, a sleep unit duration after the sleep unit command, a query repeat command that indicates a zero count of query repeat commands transmitted since the query command;
transmit one or more other query repeat commands that each indicate a count of query repeat commands transmitted since the query command; and
monitor for responses from the one or more second wireless devices.

2. The first wireless device of claim 1, wherein the processing system is configured to cause the first wireless device to receive one or more responses from the one or more second wireless devices.

3. The first wireless device of claim 1, wherein the sleep unit command has a format specific to indicating the sleep unit duration.

4. The first wireless device of claim 1, wherein the sleep unit command has a query repeat command format and one or more invalid query repeat command values.

5. A second wireless device, comprising:
a processing system that includes one or more processors and one or more code-storing memories coupled with the one or more processors, the processing system configured to cause the second wireless device to:
receive, from a first wireless device, a query command that includes a query parameter assigned to one or more second wireless devices and that requests a response from each of the one or more second wireless devices;
receive, from the first wireless device, a sleep unit command that is associated with a sleep unit duration of the second wireless device; and
receive, after the sleep unit duration following the sleep unit command, a query repeat command that indicates a zero count of query repeat commands transmitted since the query command.

6. The second wireless device of claim 5, wherein the processing system is configured to cause the second wireless device to determine a quantity of clock cycles in the sleep unit duration.

7. The second wireless device of claim 6, wherein the processing system is configured to cause the second wireless device to:
sleep for a total sleep duration that is based at least in part on the query parameter and the quantity of clock cycles in the sleep unit duration; and
wake up at an end of the total sleep duration.

8. The second wireless device of claim 7, wherein the total sleep duration is the query parameter times the sleep unit duration.

9. The second wireless device of claim 7, wherein the processing system is configured to cause the second wireless device to:
receive, from the first wireless device, a query repeat command that indicates a count of query repeat commands transmitted since a query command;
decrement a current value of a counter of the second wireless device based at least in part on the count in the query repeat command; and
transmit a response based at least in part on the counter satisfying a threshold count value.

10. The second wireless device of claim 7, wherein the processing system is configured to cause the second wireless device to scale the sleep unit duration down based at least in part on a maximum clock error value.

11. The second wireless device of claim 7, wherein the processing system is configured to cause the second wireless device to:
return to sleep based at least in part on a difference between the query parameter and a count in a received query repeat command satisfying a difference threshold, or
remain awake based at least in part on the difference not satisfying the difference threshold.

12. The second wireless device of claim 5, wherein the processing system is configured to cause the second wireless device to:
transmit a response message based at least in part on a counter for the second wireless device being zero, or
wait for a next query repeat command to respond.

13. A method of wireless communication performed by a second wireless device, comprising:
receiving, from a first wireless device, a query command that includes a query parameter assigned to one or more second wireless devices and that requests a response from each of the one or more second wireless devices;
receiving, from the first wireless device, a sleep unit command that is associated with a sleep unit duration of the second wireless device; and
receiving, after the sleep unit duration following the sleep unit command, a query repeat command that indicates a zero count of query repeat commands transmitted since the query command.

14. The method of claim 13, further comprising determining a quantity of clock cycles in the sleep unit duration.

15. The method of claim 14, further comprising:
sleeping for a total sleep duration that is based at least in part on the query parameter and the quantity of clock cycles in the sleep unit duration; and
waking up at an end of the total sleep duration.

16. The method of claim 15, wherein the total sleep duration is the query parameter times the sleep unit duration.

17. The method of claim 15, further comprising:
receiving, from the first wireless device, a query repeat command that indicates a count of query repeat commands transmitted since a query command;
decrementing a current value of a counter of the second wireless device based at least in part on the count in the query repeat command; and
transmitting a response based at least in part on the counter satisfying a threshold count value.

18. The method of claim 15, further comprising scaling the sleep unit duration down based at least in part on a maximum clock error value.

19. The method of claim 15, further comprising:
returning to sleep based at least in part on a difference between the query parameter and a count in a received query repeat command satisfying a difference threshold, or
remaining awake based at least in part on the difference not satisfying the difference threshold.

20. The method of claim 13, further comprising:
transmitting a response message based at least in part on a counter for the second wireless device being zero, or
waiting for a next query repeat command to respond.
